(19) United States
(12) Patent Application Publication
(10) Pub. No.: US 2015/0369588 A1
(43) Pub. Date: Dec. 24, 2015

(54) OPTICAL MEASUREMENT APPARATUS AND METHOD OF CONTROLLING THE SAME

(71) Applicant: SAMSUNG ELECTRONICS CO., LTD., Suwon-si (KR)

(72) Inventors: Kwang Soo KIM, Suwon-si (KR); Hyun Jae LEE, Suwon-si (KR); Byeong Hwan JEON, Yongin-si (KR); Chang Hoon CHOI, Suwon-si (KR)

(73) Assignee: SAMSUNG ELECTRONICS CO., LTD., Suwon-si (KR)

(21) Appl. No.: 14/839,553

(22) Filed: Aug. 28, 2015

Related U.S. Application Data
(62) Division of application No. 13/927,843, filed on Jun. 26, 2013.

(30) Foreign Application Priority Data
Jun. 27, 2012 (KR) 10-2012-0069130

(51) Int. Cl. G01B 11/00

(52) U.S. Cl. CPC G01B 11/00

(57) ABSTRACT

According to example embodiments, an optical measurement apparatus may include: a station configured to support a measurement target; an image acquisition unit configured to acquire a one-dimensional (1D) line image of the measurement target; a driver configured to move the station and the image acquisition unit; and a controller. The controller may be configured to control the driver and the image acquisition unit to acquire a plurality of 1D line images of the measurement target while varying a distance between the image acquisition unit and the measurement target to generate a two-dimensional (2D) scan image from combining the plurality of 1D line images; and to detect a pattern of the measurement target based on comparing a plurality of 2D reference images and the 2D scan image. The optical measurement apparatus may measure critical dimensions of non-repeating ultrafine patterns at high speed.

### CROSS-REFERENCE TO RELATED APPLICATION(S)

This application is a divisional of U.S. application Ser. No. 13/927,843, filed on Jun. 26, 2013, which claims priority under 35 U.S.C. §119 to Korean Patent Application No. 2012-0069130, filed on Jun. 27, 2012 in the Korean Intellectual Property Office, the entire of each of which are hereby incorporate by reference.

### BACKGROUND

1. Field

Example embodiments relate to an optical measurement apparatus for measuring a critical dimension of ultrafine patterns and/or a method of controlling the same.

2. Description of the Related Art

An integrated circuit (IC) may be manufactured using various processes including wafer preparation, oxide layer formation, impurity diffusion, impurity ion implantation, deposition, etching, photolithography, and the like.

Among these processes, through photolithography and etching, patterns constituting an electrical circuit intended by a designer may be formed on a semiconductor substrate.

Photolithography refers to a process of forming an electric circuit, outlines of which are drawn on a mask, on the semiconductor substrate by reduction projecting the mask on which outlines of devices and signal lines constituting the electrical circuit are drawn, onto the semiconductor device. Etching refers to a process of removing unnecessary portions except for patterns formed using the mask.

After photolithography and etching are performed, an inspection may be done to check whether the pattern intended by the designer is appropriately formed on the semiconductor substrate. In this case, the inspection may check whether or not the patterns are formed to sizes desired by the designer as well as whether or not some of patterns desired by the designer are lost or unwanted patterns are formed. Likewise, measurement regarding whether patterns having sizes desired by a designer are formed is referred to as critical dimension measurement.

Conventionally, a measurement apparatus for measurement of critical dimension of patterns formed on a semiconductor substrate is, for example, an apparatus using an electronic beam, represented as a scanning electron microscope (SEM), and an apparatus using light within a specific wavelength range, represented as an optical critical dimension (OCD) measurement apparatus.

A SEM may measure critical dimensions of fine patterns compared with an optical microscope. However, a measurement speed of the SEM may be reduced with respect to recently developed ultrafine patterns of 200 nm or less.

An OCD measurement apparatus may emit measurement light in a specific wavelength range to a target object, obtain a wedge graph of each wavelength, and search for a wedge graph corresponding to the wedge graph of each wavelength from a database generated in advance to calculate critical dimensions of patterns. The OCD measurement apparatus may measure only repeated patterns, and may increase manufacturing costs due to high cost thereof.

### SUMMARY

Example embodiments relate to an optical measurement apparatus for measuring critical dimensions of ultrafine patterns (e.g., non-repeating ultrafine patterns), and/or a method of controlling the optical measurement apparatus.

Additional aspects will be apparent from the description that follows and/or may be learned by practice of example embodiments.

According to example embodiments, an optical measurement apparatus includes: a station configured to support a measurement target; an image acquisition unit configured to acquire a one-dimensional (1D) line image of the measurement target; a driver configured to move the station and the image acquisition unit; and a controller. The controller may be configured to control the driver and the image acquisition unit to acquire a plurality of 1D line images of the measurement target while varying a distance between the image acquisition unit and the measurement target. The controller may also be configured to combine generate a two-dimensional (2D) scan image from combining the plurality of 1D line images, and to detect a pattern of the measurement target based on comparing a plurality of 2D reference images and the 2D scan image.

In example embodiments, the optical measurement apparatus may further include a storage unit to store the plural 2D reference images.

In example embodiments, the controller may be configured to: calculate differences between the plurality of 2D reference images and the 2D scan image, select a 2D reference image having a minimum difference from the 2D scan image among the plurality of 2D reference images, and determine that a critical dimension of the pattern of the measurement target is the same as a critical dimension of a pattern of a reference target corresponding to the selected 2D reference image.

In example embodiments, the optical measurement apparatus may further include an input unit connected to the controller. The input unit may be configured to receive an image acquisition range, image acquisition time interval, or image acquisition number of times. The controller may be configured to control the acquisition of the plurality of 1D line image of the measurement target by the image acquisition unit, based on the image acquisition range, image acquisition time interval, or image acquisition number of times received by the input unit.

In example embodiments, the image acquisition unit may further include a light emitter configured to emit light in a direction perpendicular to the measurement target.

In example embodiments, the image acquisition unit may include at least one lens to capture an image of the measurement target, and a line scan camera to capture the 1D line image. The line scan camera may detect luminous intensity of light reflected or scattered by the measurement target.

In example embodiments, the driver may be configured to move the station or the image acquisition unit in a direction perpendicular to the measurement target.

In example embodiments, the driver may be configured to move the station to change a distance between the image acquisition unit and the measurement target or move the image acquisition unit to change the distance between the image acquisition unit and the measurement target.

In example embodiments, the controller may be configured to: calculate mean squares of differences between luminous intensities of pixels of the 2D scan image and luminous intensities of corresponding pixels of the plurality of 2D reference images; select a 2D reference image having a minimum mean squares of differences in luminous intensity of pixels from the 2D scan image among the plurality of 2D reference images; and determine that a critical dimension of the pattern of the measurement target is the same a critical dimension of a reference target corresponding to the selected 2D reference image.

In example embodiments, the controller may be configured to: calculate mean absolute values of differences between luminous intensities of pixels of the 2D scan image and luminous intensities of corresponding pixels of the plurality of 2D reference images; select a 2D reference image having a minimum mean absolute value of differences in luminous intensity of pixels from the 2D scan image among the plurality of 2D reference images; and determine that a critical dimension of the pattern of the measurement target is the same a critical dimension of a reference target corresponding to the selected 2D reference image.

According to example embodiments, a method of controlling an optical measurement apparatus includes: acquiring a plurality of 1D line image of a measurement target while varying a distance between an image acquisition unit and the measurement target; generating a 2D scan image from combining the plurality of 1D line images; and detecting a pattern of the measurement target based on comparing the 2D scan image and a plurality of reference images.

In example embodiments, the method may further include generating a 2D reference image with respect to the reference targets.

In example embodiments, the detecting the pattern of the measurement target may include: calculating differences between the plurality of 2D reference images and the 2D scan image; selecting one of the plurality of 2D reference images that has a minimum difference from the 2D scan image among the plurality of 2D reference images; and determining a critical dimension of the pattern of the measurement target is the same as a critical dimension of a pattern of a reference target corresponding to the selected 2D reference image.

In example embodiments, the method may further include receiving an image acquisition range, image acquisition time interval, or image acquisition number of times for acquisition of the plurality of 1D line images of the measurement target by the image acquisition unit.

In example embodiments, the acquiring the plurality of 1D line images may include acquiring luminous intensity of light reflected or scattered by the measurement target while varying the distance between the image acquisition unit and the measurement target.

In example embodiments, the method may include moving the image acquisition unit in a direction perpendicular to the measurement target to change a distance between the image acquisition unit and the measurement target or moving the station in a direction perpendicular to the measurement target to change the distance between the image acquisition unit and the measurement target.

In example embodiments, the calculating differences between the plurality of 2D reference images and the 2D scan image may include calculating mean absolute values of differences between luminous intensities of pixels of the 2D scan image and luminous intensities of corresponding pixels of the 2D reference image as the difference between the 2D scan image and the plurality of 2D reference images.

In example embodiments, the calculating differences between the plurality of 2D reference images and the 2D scan image may include calculating mean squares of differences between luminous intensities of pixels of the 2D scan image and luminous intensities of corresponding pixels of the 2D reference image as the difference between the 2D scan image and the 2D reference image

According to example embodiments, an optical measurement apparatus may include: a station configured to support a measurement target; an image acquisition unit configured to acquire a one-dimensional (1D) line image corresponding to luminous intensity of light reflected or scattered by the measurement target; a driver configured to adjust a distance between the station and the image acquisition unit; and a controller. The controller may be configured to control the driver and the image acquisition unit while the driver adjusts the distance between the station and the image acquisition unit to a plurality of different distances and the image acquisition unit acquires a plurality of 1D line images of the measurement target. Each one of the plurality of 1D line images may be acquired at a different one of the plurality of different distances. The controller may be configured to generate a two-dimensional (2D) scan image from the plurality of 1D line images, the controller may be configured to detect a pattern of the measurement target based on comparing a plurality of 2D reference images to the 2D scan image.

In example embodiments, the controller may be configured to calculate differences between the plurality of 2D reference images and the 2D scan image; select a 2D reference image having a minimum difference from the 2D scan image among the plurality of reference 2D images; and determine that a critical dimension of the pattern of the measurement target is the same as a critical dimension of a pattern of a reference target corresponding to the selected 2D reference image.

In example embodiments, the 2D scan image and the plurality of 2D reference images may include pixels having values corresponding to luminous intensity, and the controller may be configured to: calculate mean squares of differences between the luminous intensities of pixels in the 2D scan image and the luminous intensities in corresponding pixels in the plurality of 2D reference images; select a 2D reference image having a minimum mean square difference in luminous intensity of pixels among the plurality of 2D reference images compared to the 2D scan images; and determine that a critical dimension of the pattern of the measurement target is the same as a critical dimension of a pattern of a reference target corresponding to the selected 2D reference image.

In example embodiments, the image acquisition unit may include: at least one lens configured to capture an image of the measurement target; and a line scan camera configured to capture the plurality of 1D line images.

In example embodiments, the optical measurement apparatus may further include a light emitter configured to emit light in a direction perpendicular to the measurement target.

In example embodiments, critical dimensions of patterns such as non-repeating ultrafine patterns may be measured, and manufacturing costs may be reduced using inexpensive measurement apparatuses.

### BRIEF DESCRIPTION OF THE DRAWINGS

The foregoing and other features and advantages of example embodiments will be apparent from the more particular description of non-limiting embodiments of, as illustrated in the accompanying drawings in which like reference characters refer to the same parts throughout the different views. The drawings are not necessarily to scale, emphasis instead being placed upon illustrating principles of example embodiments. In the drawings:

FIG. 1 is a diagram showing an interference phenomenon that occurs between light beams that are reflected or scattered by a pattern when light is emitted to the pattern formed on a semiconductor substrate;

FIG. 2 is a schematic perspective view of an optical measurement apparatus according to example embodiments;

FIG. 3 is a schematic block diagram of the optical measurement apparatus shown in FIG. 2;

FIG. 4 is a schematic diagram showing lenses of an optical measurement apparatus and a case in which the lenses capture an image of a pattern formed on a semiconductor substrate, according to example embodiments;

FIG. 5 is a conceptual diagram of a case in which an image acquisition unit acquires a one-dimensional (1D) line image while a station of an optical measurement apparatus is moved, according to example embodiments;

FIG. 6 is a conceptual diagram of a case in which an image acquisition unit acquires a 1D line image while an image acquisition unit of an optical measurement apparatus is moved, according to example embodiments;

FIG. 7 is a schematic diagram showing lenses of an image acquisition unit and a case in which the lenses capture an image of a pattern formed on a semiconductor substrate, according to example embodiments;

FIG. 8 is a diagram showing luminous intensity of a 1D line image acquired according to a distance between a station and an image acquisition unit of an optical measurement apparatus according to example embodiments;

FIG. 9 is a diagram of a two-dimensional (2D) scan image generated by an optical measurement apparatus according to example embodiments; and

FIG. 10 is a flowchart of an optical measurement method in a time sequence according to example embodiments.

### DETAILED DESCRIPTION

Example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided so that this disclosure will be thorough and complete, and will fully convey the scope of example embodiments to those of ordinary skill in the art. In the drawings, the thicknesses of layers and regions are exaggerated for clarity. Like reference numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof. Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

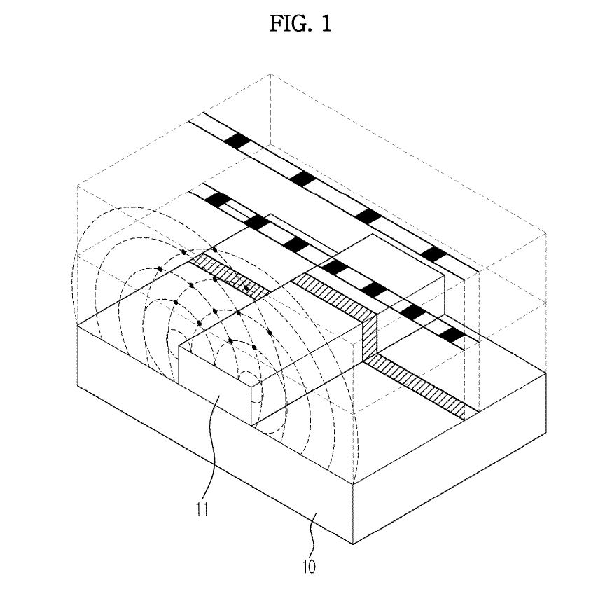

FIG. 1 is a diagram showing an interference phenomenon that occurs between light beams that are reflected or scattered by a pattern 11 when light is emitted to the pattern 11. The pattern 11 may be formed on a semiconductor substrate 10.

As shown in FIG. 1, light beams emitted to edges of the pattern 11 may be scattered in a radial form by the edges of the pattern 11 having a linear shape. In this case, light beams scattered in a radial form at opposite edges of the pattern 11 may interfere with each other.

Light corresponding to electromagnetic waves may undergo constructive interference and/or destructive interference. Constructive interference increases luminous intensity and may occur at points where a waveform valley meets another waveform valley or a waveform ridge meets another waveform ridge. Destructive interference may reduce luminous intensity and may occur at points where a waveform valley meets a waveform ridge.

Thus, intensities of light beams reflected or scattered by the pattern 11 may be detected at a position spaced apart from the pattern 11 by a specific distance in order to acquire a striped image. The striped image may include relatively light areas due to constructive interference and relatively dark areas due to destructive interference, and the relatively light and/or dark areas may be repeatedly positioned. With regard to the striped image, features such as an interval between stripes, positions of the stripes, the brightness of the stripes, and the like may differ according to the width, height, and inclination of the pattern 11.

In addition, compared with the aforementioned case, when intensities of light beams reflected or scattered by a portion that is spaced apart from another pattern 11 (e.g., a pattern having a different width, height, or inclination), are detected, positions where constructive interference and destructive interference occur are different from the aforementioned case. As a result, a striped image having a different interval between stripes, different positions of the stripes, and different brightness of the stripes may be acquired.

In addition, when intensities of light beams reflected or scattered by a portion that is spaced apart from the pattern 11 by a different distance from the specific distance, are detected, positions where constructive interference and destructive interference occur are different from the aforementioned cases. Thus, a striped image having a different interval between stripes, different positions of the stripes, and different brightness of the stripes may be acquired.

Based on such stripe images, critical dimensions of the pattern 11 (e.g., the width, height, and inclination) formed on the semiconductor substrate 10 may be measured and/or determined. In detail, when a reference striped image of a reference pattern is known in advance, a comparison may be made between the reference pattern and a striped image acquired from a target pattern that has been measure. The comparison may be used to measure critical dimensions of the target pattern.

Here, the reference pattern may differ according to a shape of the target pattern, critical dimensions of which are to be measured. For example, when the target pattern (critical dimensions of which are to be measured) has a rectangular parallelepiped shape having a long length compared with a width and a height (such as a signal line or a gate of a metal oxide silicon field effect transistor (MOSFET) on a semiconductor substrate), it may be possible to use a plurality of patterns having different widths, a plurality of patterns having different heights, or a plurality of patterns having different inclinations, as the reference pattern.

In addition, intensities of light beams reflected or scattered by pattern 11 may be detected, at a position spaced apart from the pattern 11 by another distance, to acquire striped images. Then, the acquired striped images are combined according to the distances from the pattern 11 to generate a three-dimensional (3D) striped image. The generated 3D striped image is compared with a 3D striped image generated from the reference pattern, and thus, the critical dimensions of the pattern 11 may be more accurately measured.

In detail, when differences between 3D reference striped images acquired from a plurality of reference patterns and a 3D striped image acquired from the pattern 11 (critical dimensions of which are to be measured) are calculated, and a 3D reference striped image having a minimum difference is selected from the compared 3D reference striped images, it may be determined that the pattern 11 (critical dimensions of which are to be measured) has the same critical dimensions as those of a reference pattern from which the selected 3D reference striped image is acquired.

However, it is not necessary to acquire intensities of light reflected or scattered by the pattern 11 (critical dimensions of which are to be measured) with respect to all patterns formed on the semiconductor substrate 10. That is, it is not necessary to acquire intensities of light reflected or scattered by the all patterns as 2D striped images.

That is, a designer may be interested in only critical dimension, that is, the width, height, or inclination of the pattern 11. Thus, sufficient information may be obtained based on only one-dimensional (1D) line image across the pattern 11 in order to measure the critical dimensions of the pattern 11.

Thus, as shown in FIG. 1, intensities of light beams reflected or scattered by the pattern 11 (critical dimensions of which are to be measured) are detected across the pattern 11 to acquire the 1D line image.

Intensities of light beams reflected or scattered by portions, which are spaced apart from the pattern 11 (critical dimensions of which are to be measured) by different distances, may be detected to acquire a plurality of 1D line images. Then, the plurality of 1D line images may be combined according to the distances from the pattern 11 to generate a 2D scan image.

Based on only the 2D scan image, the critical dimensions of the pattern 11, may be measured. That is, 2D reference images generated from a plurality of reference patterns and the 2D scan image generated from the pattern 11 to be measured may be compared to measure the critical dimensions of the pattern 11.

An optical measurement apparatus according to example embodiments uses the aforementioned principle. In addition, an optical measurement apparatus according to example embodiments may measure critical dimensions of patterns constituting an electrical circuit of an integrated circuit (IC), and thus, it may be assumed that a measurement target is patterns formed on a semiconductor substrate.

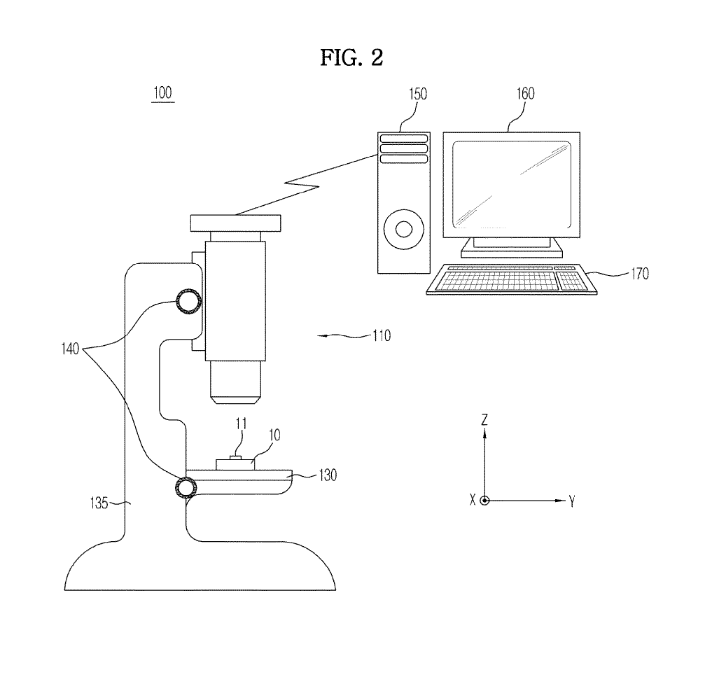

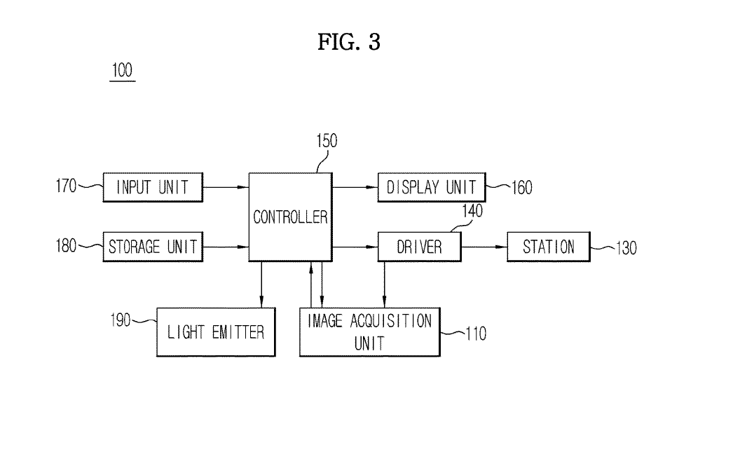

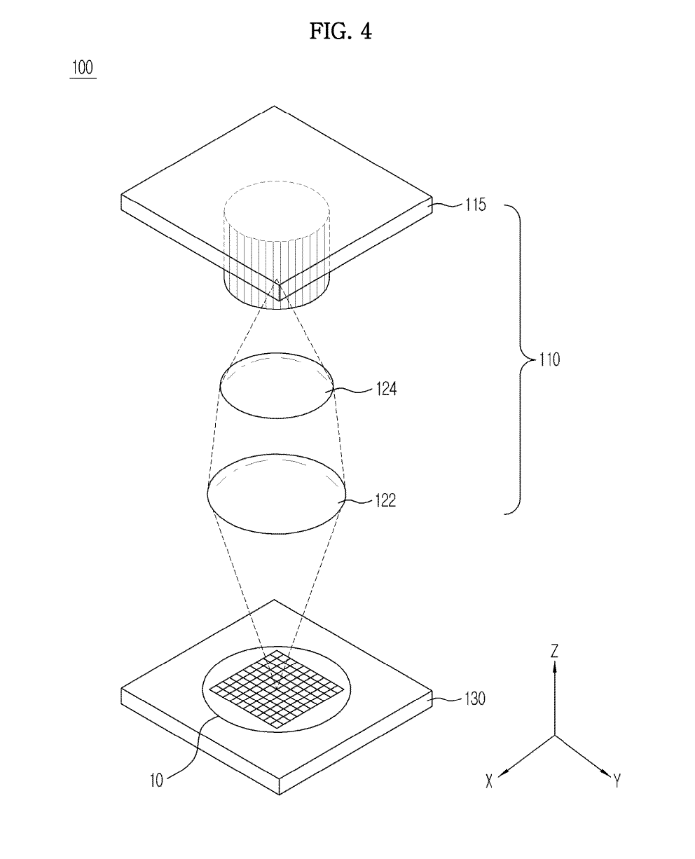

FIG. 2 is a schematic perspective view of an optical measurement apparatus 100 according to example embodiments, FIG. 3 is a schematic block diagram of the optical measurement apparatus 100 shown in FIG. 2, and FIG. 4 is a schematic diagram showing lenses 122 and 124 of an optical measurement apparatus and a case in which the lenses 122 and 124 capture an image of the pattern 11 formed on the semiconductor substrate 10, according to example embodiments.

Referring to FIGS. 2, 3, and 4, according to example embodiments, the optical measurement apparatus 100 may include: a station 130 to support the semiconductor substrate 10; an image acquisition unit 110 including at least one lens, for example the lenses 122 and 124 to capture a striped image (hereinafter, referred to as the “pattern image”) formed according to interference between light beams reflected or scattered by the pattern 11 formed on the semiconductor substrate 10, and a line scan camera 115 to acquire a 1D line image from images captured by the lenses 122 and 124; an arm 135 to secure the image acquisition unit 110 and the station 130; a driver 140 to change a distance between the image acquisition unit 110 and the station 130; a controller 150 to combine a plurality of 1D line images acquired by the image acquisition unit 110 to generate a 2D scan image; a display unit 160 to display the 2D scan image generated by the controller 150; and an input unit 170 to receive an operation command from a user.

The station 130 fixes the semiconductor substrate 10 during a process of measuring critical dimensions of the pattern 11 formed on the semiconductor substrate 10. The station 130 limits (and/or prevents) the semiconductor substrate 10 from moving during the process of measuring critical dimensions of the pattern 11.

The station 130 may be moved in an X-axis or Y-axis direction shown in FIG. 2 so as to position a focus of an objective lens 122 of the image acquisition unit 110 on the pattern 11 formed on the semiconductor substrate 10. In addition, the station 130 may be moved in a Z-axis direction shown in FIG. 2 so as to change a distance between the image acquisition unit 110 and the semiconductor substrate 10 on which the pattern 11 (critical dimensions of which are to be measured) is formed.

The image acquisition unit 110 may include lenses 122 and 124 to capture images of the pattern 11 formed on the semiconductor substrate 10 and the line scan camera 115. The line scan camera 115 may acquire the 1D line image from the images captured by the lenses 122 and 124.

The lenses 122 and 124 enlarge or reduce an image of the pattern 11 formed on the semiconductor substrate 10 and capture the enlarged or reduced image. The lenses 122 and 124 may include the objective lens 122 positioned adjacent to the semiconductor substrate 10 to enlarge an image of the pattern 11 formed on the semiconductor substrate 10, and an ocular lens 124 positioned adjacent to the line scan camera 115 to further enlarge the image enlarged by the objective lens 122 (refer to FIG. 3).

The line scan camera 115 acquires the 1D line image from the image enlarged by the lenses 122 and 124. The line scan camera 115 acquires the 1D line image from the pattern 11 formed on the semiconductor substrate 10. In this case, the 1D line image acquired by the line scan camera 115 may be acquired across the pattern 11 (critical dimensions of which are to be measured), as shown in FIG. 1.

The line scan camera 115 may include a digital camera such as a camera or the like including a charge-coupled device (CCD) to convert an optical signal into an electrical signal. In addition, the line scan camera 115 may include one line of optical sensor or two or more optical sensors, which each constitute a pixel as a unit of an image.

In a general image acquisition apparatus, an area scan camera may include a plurality of optical sensors that are arranged in both vertical and horizontal directions to acquire a 2D image of a specific region.

On the other hand, a line scan camera includes a plurality of optical sensors that are arranged in only a vertical or horizontal direction to acquire a 1D line image having a linear shape. In order to acquire a 2D area image using the line scan camera, a target object or the line scan camera may be moved at a constant speed. That is, the target object and the line scan camera may be moved at a constant relative speed, the line scan camera may acquire 1D line images having a linear shape at a desired (and/or alternatively predetermined) time interval, and the 1D line images having a linear shape may be combined to acquire a 2D image.

As described later, according to example embodiments, the line scan camera 115 of the optical measurement apparatus 100 acquires a plurality of 1D line images of the pattern 11 formed on the semiconductor substrate 10 while changing a distance between the line scan camera 115 and the semiconductor substrate 10. The controller 150 may combine the plural 1D line images according to the distance therebetween to generate a 2D scan image.

The line scan camera 115 acquires the 1D line image via one line of optical sensors. Thus, it takes a relatively short time to acquire the 1D line image compared with an area scan camera which acquires a 2D image via a plurality of optical sensors arranged in both vertical and horizontal directions. Thus, the line scan camera 115 may acquire an image of the pattern 11 formed on the semiconductor substrate 10 at high speed, and also combine 1D line images having a linear shape, acquired at high speed, to generate the 2D scan image.

According to example embodiments, the line scan camera 115 of the optical measurement apparatus 100 acquires luminous intensity. In other words, in example embodiments, the image acquisition unit 110 may measure luminous intensity of light beams which are reflected or scattered by the pattern 11 formed on the semiconductor substrate 10 to cause an interference phenomenon.

The driver 140 changes a distance between the image acquisition unit 110 and the pattern 11 formed on the semiconductor substrate 10, which is subjected to measurement. In particular, the driver 140 may move the station 130 or the image acquisition unit 110 such that the focus of the objective lens 122 of the image acquisition unit 110 may pass through the pattern 11 formed on the semiconductor substrate 10.

In addition, the driver 140 may move the station 130 or the image acquisition unit 110 in a perpendicular direction to the semiconductor substrate 10 so as to move the focus of the objective lens 122 of the image acquisition unit 110 in the perpendicular direction to the semiconductor substrate 10.

Referring to FIG. 4, the driver 140 may move the station 130 or the image acquisition unit 110 in a Z-axis direction so as to move the focus of the objective lens 122 of the image acquisition unit 110 in the Z-axis direction.

In order to change the distance between the image acquisition unit 110 and the pattern 11 formed on the semiconductor substrate 10, the following three methods may be used.

As a first method, the driver 140 moves the station 130 in the Z-axis direction so as to move the semiconductor substrate 10 in the Z-axis direction. The driver 140 may fix a position of the image acquisition unit 110 and move the station 130 in the Z-axis direction so as to change a relative distance between the image acquisition unit 110 and the pattern 11 formed on the semiconductor substrate 10.

As a second method, the driver 140 moves the image acquisition unit 110 in the Z-axis direction. The driver 140 may fix a position of the station 130 to fix a position of the semiconductor substrate 10 and move the image acquisition unit 110 in the Z-axis direction so as to change the relative distance between the image acquisition unit 110 and the pattern 11 formed on the semiconductor substrate 10.

As a third method, the driver 140 moves the objective lens 122 of the image acquisition unit 110 or the objective lens 122 and the ocular lens 124 in the Z-axis direction. The driver 140 may fix the position of the station 130 to fix the position of the semiconductor substrate 10 and move the objective lens 122 of the image acquisition unit 110 or the objective lens 122 and the ocular lens 124 in the Z-axis direction to change the relative distance between the pattern 11 formed on the semiconductor substrate 10 and the objective lens 122 of the image acquisition unit 110 or the objective lens 122 and the ocular lens 124 of the image acquisition unit 110.

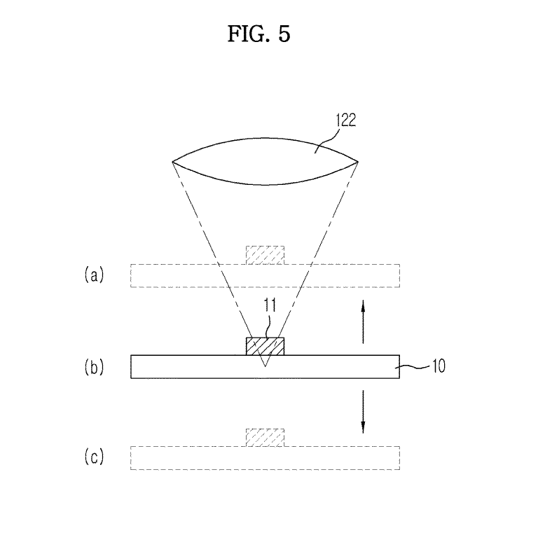

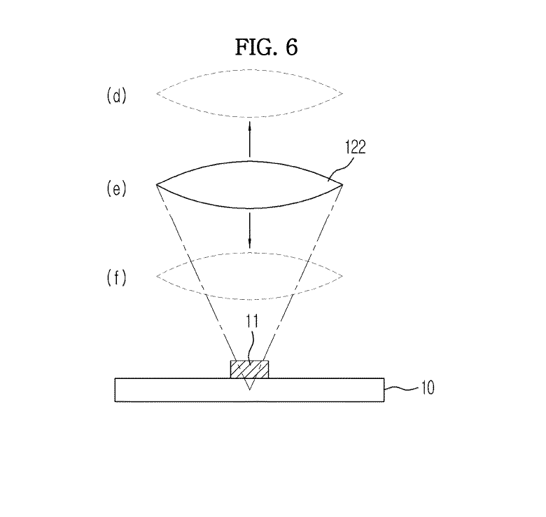

FIG. 5 is a conceptual diagram of a case in which the image acquisition unit 110 acquires a 1D line image while the station 130 of an optical measurement apparatus is moved, according to example embodiments and FIG. 6 is a conceptual diagram of a case in which the image acquisition unit 110 acquires a 1D line image while the image acquisition unit 110 of an optical measurement apparatus is moved, according to example embodiments.

In detail, FIG. 5 shows a relative position between the semiconductor substrate 10 and the focus of the objective lens 122 of the image acquisition unit 110 when the driver 140 fixes the position of the image acquisition unit 110 and moves the station 130.

When the driver 140 moves the station 130 to position the semiconductor substrate 10 at a position (a), the focus of the objective lens 122 of the image acquisition unit 110 may be positioned below the pattern 11 formed on the semiconductor substrate 10. Thus, the image acquisition unit 110 may acquire an unclear image of the pattern 11 because the objective lens 122 is out of focus.

When the semiconductor substrate 10 is positioned at a position (b), the focus of the objective lens 122 of the image acquisition unit 110 is positioned on the pattern 11. Thus, the image acquisition unit 110 may acquire an image reflected by the pattern 11 formed on the semiconductor substrate 10.

When the semiconductor substrate 10 is positioned at a position (c), the focus of the objective lens 122 of the image acquisition unit 110 is positioned above the pattern 11. Thus, the image acquisition unit 110 may acquire an image generated from light beams which are scattered by the pattern 11 of the semiconductor substrate 10 to generate an interference phenomenon.

In detail, while the semiconductor substrate 10 is moved from the position (a) to the position (b), the focus of the objective lens 122 of the image acquisition unit 110 is moved from a portion below the pattern 11 formed on the semiconductor substrate 10 onto the pattern 11. As the semiconductor substrate 10 is moved from the position (a) to the position (b), an image of the pattern 11, acquired by the image acquisition unit 110, is changed to a clear image from an unclear image formed since the objective lens 122 is out of focus. In addition, while the semiconductor substrate 10 is moved from the position (b) to the position (c), the focus of the objective lens 122 of the image acquisition unit 110 is moved from a portion positioned on the pattern 11 formed on the semiconductor substrate 10 to a portion above the pattern 11. In addition, as the semiconductor substrate 10 is moved from the position (b) to the position (c), an image of the pattern 11, acquired by the image acquisition unit 110, is changed from an image reflected by the pattern 11 to an image generated due to interference between light beams scattered by the pattern 11.

In this case, with respect to a relationship with the semiconductor substrate 10, a position of the focus of the objective lens 122 of the image acquisition unit 110 is changed in only a Z-axis direction, and is not changed in an X-axis or Y-axis direction. That is, the driver 140 moves the station 130 to fix the semiconductor substrate 10 in only the Z-axis direction, and does not move the station 130 in the X-axis or Y-axis direction.

FIG. 6 shows a relative position between the pattern 11 formed on the semiconductor substrate 10 and the focus of the objective lens 122 of the image acquisition unit 110 when the driver 140 fixes the position of the station 130 and moves the image acquisition unit 110.

When the objective lens 122 of the image acquisition unit 110 is positioned at a position (d), the focus of the objective lens 122 is positioned above the pattern 11 formed on the semiconductor substrate 10. When the objective lens 122 is positioned at a position (e), the focus of the objective lens 122 is positioned on the pattern 11 formed on the semiconductor substrate 10. When the objective lens 122 is positioned at a position (f), the focus of the objective lens 122 is positioned below the pattern 11 formed on the semiconductor substrate 10.

In detail, while the objective lens 122 is moved from the position (f) to the position (d) through the position (e), the focus of the objective lens 122 is moved from a portion below the pattern 11 formed on the semiconductor substrate 10 up to a portion positioned on the pattern 11 through the pattern 11.

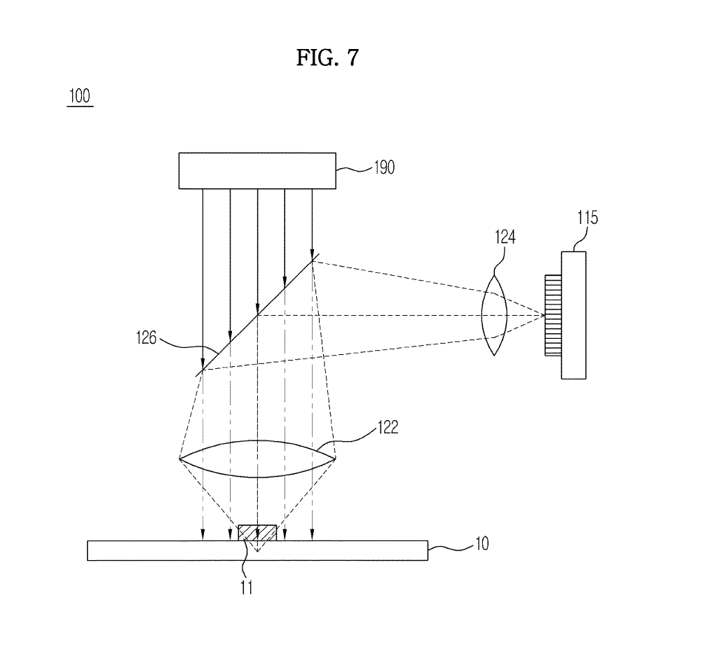

FIG. 7 is a schematic diagram showing the lenses 122 and 124 of the image acquisition unit 110 and a case in which the lenses 122 and 124 capture an image of the pattern 11 formed on the semiconductor substrate 10, according to example embodiments. In detail, FIG. 7 shows the image acquisition unit 110 when the optical measurement apparatus 100 includes a light emitter 190 to emit measurement light.

Referring to FIG. 7, the optical measurement apparatus 100 may include the light emitter 190 to emit the measurement light. The image acquisition unit 110 may further include a half mirror 126 that passes light incident thereupon in a specific direction and reflects light incident thereupon in another direction.

The light emitter 190 generates the measurement light emitted to the pattern 11 formed on the semiconductor substrate 10. The light emitter 190 may be, for example, a laser generation apparatus to emit a light amplification by stimulated emission of radiation (LASER) beam, a light emitting diode (LED) to emit light having a specific wavelength, a sodium lamp, or the like. However, example embodiments are not limited thereto

The light emitter 190 emits the measurement light in a perpendicular direction to the semiconductor substrate 10, which is subjected to measurement. In order to acquire a clear striped image according to interference between light beams scattered by the pattern 11 formed on the semiconductor substrate 10, measurement light emitted in a perpendicular direction to the semiconductor substrate 10 may be used (and/or required).

The half mirror 126 passes the measurement light emitted by the light emitter 190 and reflects light reflected or scattered by the pattern 11 formed on the semiconductor substrate 10. By virtue of the half mirror 126, it may be possible to position the light emitter 190 and the line scan camera 115 at different positions and to overcome spatial restrictions, which require that the light emitter 190 and the line scan camera 115 be positioned in the same space.

The input unit 170 may receive, from a user, an image acquisition range, an image acquisition time interval, or an image acquisition number of times of the image acquisition unit 110 with respect to the pattern 11 formed on the semiconductor substrate 10.

The input unit 170 may receive the image acquisition range from a distance between the semiconductor substrate 10 and the focus of the objective lens 122 of the image acquisition unit 110 when the image acquisition unit 110 and the semiconductor substrate 10 are closest to each other, to a distance between the semiconductor substrate 10 and the focus of the objective lens 122 of the image acquisition unit 110 when the image acquisition unit 110 and the semiconductor substrate 10 are furthermost from each other.

In this case, the image acquisition range may be set such that the focus of the objective lens 122 of the image acquisition unit 110 may pass through the pattern 11 formed on the semiconductor substrate 10.

In addition, while the distance between the image acquisition unit 110 and the semiconductor substrate 10 is changed within the aforementioned image acquisition range, the input unit 170 may further receive the image acquisition time interval at which the image acquisition unit 110 acquires images of the pattern 11 formed on the semiconductor substrate 10. While the distance between the image acquisition unit 110 and the semiconductor substrate 10 is changed within the aforementioned image acquisition range, the input unit 170 may further receive the image acquisition number of times by which the image acquisition unit 110 acquires the images of the pattern 11 formed on the semiconductor substrate 10.

The controller 150 may control the driver 140 to change the distance between the image acquisition unit 110 and the semiconductor substrate 10, and simultaneously, control the image acquisition unit 110 to acquire the image of the pattern 11 formed on the semiconductor substrate 10 while the distance between the image acquisition unit 110 and the semiconductor substrate 10 is changed.

When the user sets the image acquisition range via the input unit 170, the controller 150 may control the driver 140 to change the distance between the image acquisition unit 110 and the semiconductor substrate 10 according to the set image acquisition range.

When the user does not input the image acquisition range via the input unit 170, the controller 150 may determine the image acquisition range based on the height of the pattern 11 formed on the semiconductor substrate 10. In this case, the height of the pattern 11 formed on the semiconductor substrate 10 may be provided by a semiconductor manufacture device (not shown).

For example, when poly silicon or aluminum (Al) is deposited or an oxide layer is formed in order to form the pattern 11, the thickness of the deposited poly silicon, Al, or oxide layer may be input by the semiconductor manufacture device.

The controller 150 may further receive the image acquisition time interval or the image acquisition number of times via the input unit 170.

When the controller 150 receives the image acquisition number of times from the user via the input unit 170, the controller 150 may calculate the image acquisition time interval based on the image acquisition range and the image acquisition number of times. When the controller 150 receives the image acquisition time interval from the user via the input unit 170, the controller 150 may also calculate the image acquisition number of times based on the image acquisition range and the image acquisition time interval. That is, the controller 150 may divide the image acquisition range by the image acquisition time interval to calculate the image acquisition number of times or may divide the image acquisition range by the image acquisition number of times to calculate the image acquisition time interval.

In addition, when the controller 150 receives the image acquisition time interval and the image acquisition number of times from the user via the input unit 170, the controller 150 may calculate the image acquisition range.

When the controller 150 does not receive the image acquisition number of times or image acquisition time interval of the ID line image from the user via the input unit 170, the controller 150 may calculate the image acquisition time interval of the 1D line image based on the height of the pattern 11.

When the controller 150 receives the image acquisition range and image acquisition time interval of the 1D line image via the input unit 170 or calculates the image acquisition range and image acquisition time interval of the 1D line image, the controller 150 controls the driver 140 to position the image acquisition unit 110 and the station 130 at a first desired (e.g., minimum) relative distance. The first desired (e.g., minimum) distance between the image acquisition unit 110 and the station 130 may be obtained according to the aforementioned image acquisition range and a focal distance of the objective lens 122 of the image acquisition unit 110.

In addition, the controller 150 controls the driver 140 to increase the distance between the image acquisition unit 110 and the station 130 at constant speed, and simultaneously, controls the image acquisition unit 110 to acquire images of the pattern 11 formed on the semiconductor substrate 10 at a constant time interval.

According to example embodiments, the optical measurement apparatus 100 may be configured in such a way that the image acquisition unit 110 acquires images of the pattern 11 while increasing the distance between the image acquisition unit 110 and the station 130, which are closest to each other at first. However, example embodiments are not limited thereto. Alternatively, the image acquisition unit 110 may acquire the images of the pattern 11 while reducing the distance between the image acquisition unit 110 and the station 130, which are furthermost from each other at first.

While varying the distance between the image acquisition unit 110 and the station 130, the controller 150 may control the image acquisition unit 110 to acquire the images of the pattern 11 at a constant time interval.

The image acquisition time interval at which the image acquisition unit 110 acquires the images of the pattern 11 may be calculated based on a speed at which the distance between the image acquisition unit 110 and the station 130 is increased, and the image acquisition time interval of the 1D line image. That is, the image acquisition time interval at which the image acquisition unit 110 acquires the images may be calculated by dividing the image acquisition time interval by the speed at which the distance between the image acquisition unit 110 and the station 130 is increased.

While the distance between the image acquisition unit 110 and the station 130 is increased at constant speed, when the image acquisition unit 110 acquires the images of the pattern 11 formed on the semiconductor substrate 10 at a constant time interval, the image acquisition unit 110 may acquire the images of the pattern 11 whenever the distance between the image acquisition unit 110 and the station 130 is a specific value. That is, the image acquisition unit 110 may acquire a plurality of 1D line images according to the distance between the image acquisition unit 110 and the semiconductor substrate 10.

The following example of operating an optical measurement apparatus according to example embodiments is described below. However, it is understood that example embodiments are not limited to the following example. In the following non-limiting example, it is assumed that the focal distance of the objective lens 122 of the image acquisition unit 110 is 10 mm, the image acquisition range is from +20 μm to −20 μm, and the image acquisition time interval is 100 nm. In addition, it is assumed that the image acquisition unit 110 is moved at a speed of 4 μm/s.

Accordingly, the image acquisition unit 110 acquires total 401 1D line images and needs to acquire 40 ID line images per second, and thus, the image acquisition unit 110 acquires one ID line image every 25 ms.

The controller 150 controls the driver 140 to position the image acquisition unit 110 and the station 130 at a distance of 9.98 mm. Then, the controller 150 controls the driver 140 to move the image acquisition unit 110 toward the station 130 at a constant speed such that the distance between the image acquisition unit 110 and the station 130 is 10.02 mm. In this case, the image acquisition unit 110 is moved away from the station 130 at a speed of 4 μm/s.

While the image acquisition unit 110 and the station 130 are moved far from each other, the controller 150 controls the image acquisition unit 110 to acquire the 1D line image of the pattern 11 formed on the semiconductor substrate 10 when the distance between the image acquisition unit 110 and the station 130 is changed by 100 nm, that is, every 25 ms.

Likewise, total 401 1D line images may be acquired within the image acquisition range from −20 μm to +20 μm at an interval of 100 nm.

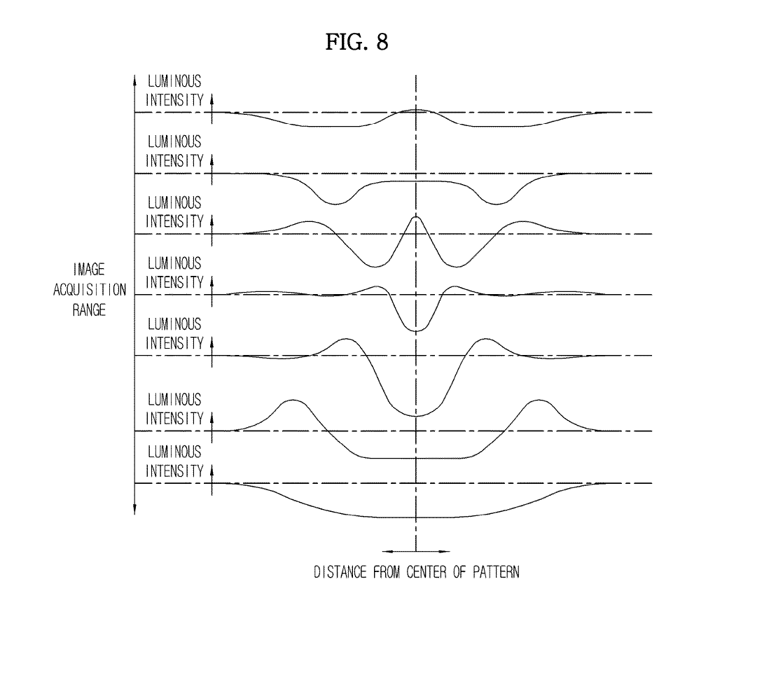

FIG. 8 is a diagram showing luminous intensity of a 1D line image acquired according to a distance between the station 130 and the image acquisition unit 110 of the optical measurement apparatus 100 according to example embodiments.

In FIG. 8, a horizontal axis indicates a distance from a center of the pattern 11 formed on the semiconductor substrate 10, and a vertical axis indicates luminous intensity.

Among a plurality of plots shown in FIG. 8, the lowermost plot shows luminous intensity of the 1D line image acquired by the image acquisition unit 110 when the image acquisition unit 110 and the semiconductor substrate 10 are closest to each other, that is, the image acquisition range is a minimum. The uppermost plot shows luminous intensity of the 1D line image acquired by the image acquisition unit 110 when the image acquisition unit 110 and the semiconductor substrate 10 are furthermost from each other, that is, the image acquisition range is a maximum. In addition, a central plot shows luminous intensity of the 1D line image acquired by the image acquisition unit 110 when the focus of the objective lens 122 of the image acquisition unit 110 is positioned on the pattern 11 formed on the semiconductor substrate 10.

As shown in FIG. 8, when the image acquisition unit 110 acquires a plurality of 1D line images, the controller 150 combines the plural 1D line images according to the distance between the image acquisition unit 110 and the semiconductor substrate 10 to generate the 2D scan image.

In detail, the controller 150 may generate the 2D scan image by positioning a first acquired 1D line image on a lowest line and stacking 1D line images in an image acquisition order while the image acquisition unit 110 acquires the plural 1D line images.

According to example embodiments, the optical measurement apparatus 100 may be configured in such a way that the image acquisition unit 110 acquires images of the pattern 11 formed on the semiconductor substrate 10 while increasing the distance between the image acquisition unit 110 and the semiconductor substrate 10, which is closest to each other at first. Thus, in the 2D scan image, the 1D line image acquired at a shortest distance between the image acquisition unit 110 and the semiconductor substrate 10 is positioned lowermost, and the 1D line image acquired at a longest distance between the image acquisition unit 110 and the semiconductor substrate 10 is positioned uppermost.

In the aforementioned example, a 1D line image acquired when the distance between the image acquisition unit 110 and the station 130 is 9980 μm, that is, a first acquired 1D line image is positioned in a lowermost line of the 2D scan line, and a 1D line image acquired when the distance between the image acquisition unit 110 and the station 130 is 9980.1 μm, that is, a 1D line image acquired after 25 ms lapses is positioned in a second line of the 2D scan image. In the same manner, a 1D line image acquired after 50 ms elapses is positioned in a third line of the 2D scan image, and a last acquired 1D line image, that is, a 1D line image acquired after 10 seconds elapses is positioned in an uppermost line of the 2D scan image.

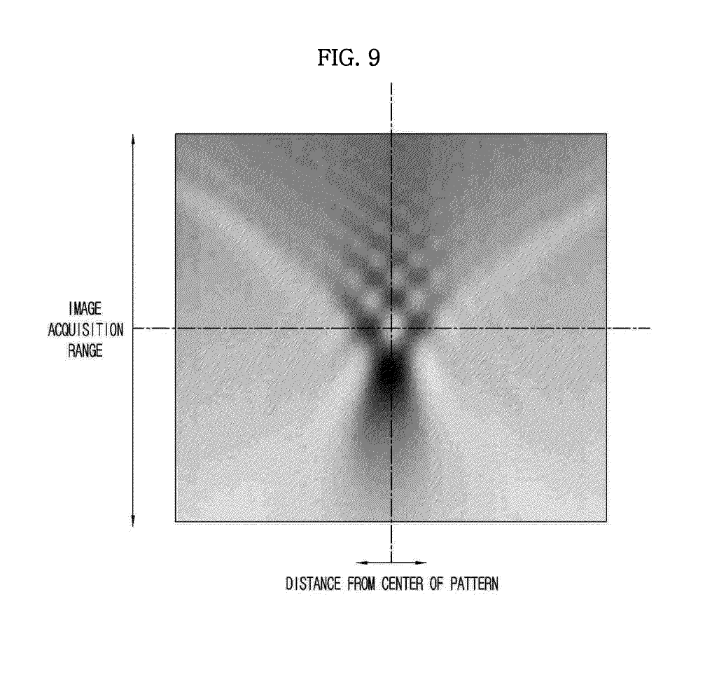

FIG. 9 is a diagram of a 2D scan image generated by the optical measurement apparatus 100 according to example embodiments.

The 2D scan image shown in FIG. 9 is displayed to exhibit different colors according to luminous intensity. That is, when luminous intensity is high, red color is displayed, and when the luminous intensity is low, blue color is displayed. However, example embodiments are not limited thereto.

A horizontal axis of the 2D scan image shown in FIG. 9 indicates a distance from a center of the pattern 11 formed on the semiconductor substrate 10 and a vertical axis indicates the image acquisition range.

The 2D scan image has a unique shape according to the pattern 11 formed on the semiconductor substrate 10.

Thus, critical dimensions of the pattern 11 formed on the semiconductor substrate 10 using an actual semiconductor manufacturing process may be measured by comparing a plurality of 2D reference images generated from a plurality of reference patterns having various widths, heights, or inclines, that is, various critical dimensions with a 2D scan images generated from the pattern 11 formed on the semiconductor substrate 10 using the actual semiconductor manufacturing process.

In addition, whether or not the pattern 11 formed using the actual semiconductor manufacturing process has critical dimensions intended by a designer may be checked by comparing a 2D reference image generated from a reference pattern having a width, height, and inclination, that is, critical dimensions desired by the designer with the 2D scan image generated from the pattern 11 formed using the actual semiconductor manufacturing process.

In order to measure the critical dimensions of the pattern 11 formed on the semiconductor substrate 10, the controller 150 generates the 2D reference image from a plurality of reference patterns having various widths, height, or inclinations, and the generated 2D reference images and the 2D scan image formed using the actual semiconductor manufacturing process are compared.

The plurality of 2D reference images may be generated using various methods.

First, the plurality of 2D reference images may be generated using computer simulation. The 2D reference images may be generated by forming imaginary patterns having various widths, height, or inclinations in a simulator, emitting measurement light to the imaginary patterns, acquiring a plurality of 1D line images from reflected or scattered light beams according to distances from the patterns, and combining the plural acquired 1D line images according to the distances from the patterns to generate the 2D reference image.

Next, the 2D reference images may be generated by preparing a plurality of identical patterns using a semiconductor manufacturing process, generating a plurality of 2D scan images using an optical measurement apparatus according to example embodiments, and then averaging the 2D scan images.

Likewise, the plurality of 2D reference images having various critical dimensions, that is, various widths, height, and inclinations may be generated.

The plurality of 2D reference images may be stored in a storage unit 180, described later, together with critical dimensions of patterns of the acquired 2D reference image.

The controller 150 calculates differences between the plurality of 2D reference images and the 2D scan image acquired from the pattern 11 formed on the actual semiconductor substrate 10 and selects a 2D reference image, the difference of which is minimized. In other words, the selected 2D reference image may be chosen based on selecting one of the plurality of 2D reference images that has a minimal difference compared to the 2D scan image.

When the 2D reference image is selected, it may be expected that critical dimensions of the patterns from which the selected 2D reference image is generated are the same as critical dimensions of the pattern 11 formed on the semiconductor substrate 10. Thus, the controller 150 determines the critical dimensions of a pattern corresponding to the selected 2D reference image as critical dimensions of the pattern 11, to be measured.

In this case, the difference between the 2D reference image and the 2D scan image may be calculated by calculating differences between luminous intensity of pixels constituting the 2D scan image and luminous intensity of the 2D reference image corresponding to the pixels and averaging the differences.

Also, the difference the between the 2D reference image and the 2D scan image may be calculated based on a mean square of differences. In detail, the mean square of difference may include calculating squares of differences between luminous intensity of pixels of the 2D scan images and luminous intensity of corresponding pixels of the 2D reference image and averaging the squares of differences between the luminous intensity of pixels of the 2D scan images and luminous intensity of corresponding pixels of the 2D reference image. Additionally, the selected 2D reference image may be chosen based on selecting one of the plurality of 2D reference images that has a minimal mean square of difference in luminous intensity compared to the 2D scan image.

Also, the difference the between the 2D reference image and the 2D scan image may be calculated based on a mean absolute value of difference. The mean absolute value of difference may include calculating absolute values of differences between luminous intensity of pixels of the 2D scan images and luminous intensity of corresponding pixels of the 2D reference image, and averaging the calculated absolute values between the luminous intensity of pixels of the 2D scan images and luminous intensity of corresponding pixels of the 2D reference image. Additionally, the selected 2D reference image may be chosen based on selecting one of the plurality of 2D reference images that has a minimal mean absolute value of difference in luminous intensity compared to the 2D scan image.

As described above, the storage unit 180 stores the 2D reference images generated from reference patterns having various widths, heights, or inclinations, that is, various critical dimensions. The storage unit 180 provides the 2D reference images and critical dimensions of patterns corresponding thereto to the controller 150 according to request of the controller 150.

The display unit 160 displays the 2D scan image generated according to control of the controller 150. The display unit 160 may display the 2D scan image while varying colors according to luminous intensity of pixels of the 2D scan image. Alternatively, the display unit 160 may display the 2D scan image while varying a shading degree according to luminous intensity of pixels of the 2D scan image.

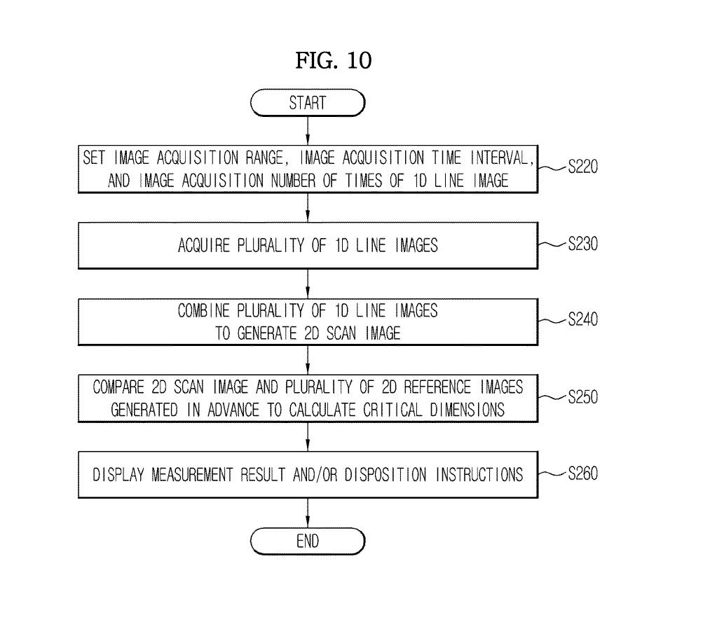

FIG. 10 is a flowchart of an optical measurement method in a time sequence according to example embodiments.

Hereinafter, an optical measurement method will be described with reference to FIG. 10.

The image acquisition range, image acquisition time interval, and image acquisition number of times of the optical measurement apparatus 100 are set (S220). The image acquisition range, the image acquisition time interval, and the image acquisition number of times may be input by a user via the input unit 170 or may be directly calculated by the controller 150.

Then, the distance between the image acquisition unit 110 and the semiconductor substrate 10 is changed to acquire a plurality of 1D line images (S230).

Then, the plural 1D line images are combined according to the distance between the image acquisition unit 110 and the semiconductor substrate 10 to generate a 2D scan image (S240).

Then, the 2D scan image and a plurality of 2D reference images generated using computer simulation or an actual semiconductor manufacturing process in advance are compared to determine critical dimensions of the pattern 11 formed on the semiconductor substrate 10 (S250).

Then, after the critical dimensional of the pattern 11 formed on the semiconductor substrate 10 are determined, the controller 150 may direct the display unit 160 to display a measurement result that indicates the critical dimensions of the pattern 11 (S260). For example, the display unit 160 may display the measurement result in the form of a chart that indicates whether the critical dimensions of the pattern 11 are within a target range for the pattern intended by the designer. The chart may include data points for critical dimensions of other measurement targets processed off of the same lithography and/or etching equipment as the semiconductor substrate 10 including the pattern 11. However, example embodiments are not limited thereto.

Additionally, the controller 150 may direct the display unit 150 to display disposition instructions for the semiconductor substrate 10 including the pattern 11 (S260). For example, if the controller 150 determines that the critical dimensions of the pattern 11 are within a desired range, the controller 150 may direct the display unit 160 to display disposition instructions that inform an operator that the semiconductor substrate 10 including the pattern 11 may proceed to the next manufacturing process. On the contrary, if the if the controller 150 determines that the critical dimensions of the pattern 11 are not within a desired range, the controller 150 may direct the display unit 160 to display disposition instructions that inform an operator that the semiconductor substrate 10 including the pattern 11 may need corrective action or need to be scrapped.

While some example embodiments have been particularly shown and described, it will be understood by one of ordinary skill in the art that variations in form and detail may be made therein without departing from the spirit and scope of the claims.

1.-20. (canceled)

21. An optical measurement apparatus comprising:
a station configured to support a measurement target;
an image acquisition unit configured to acquire a one-dimensional (1D) line image by measuring an intensity of an interference phenomenon generated between reflected or scattered light beams from the measurement target;
a driver configured to move the station and the image acquisition unit; and
a controller,
the controller being configured to control the driver and the image acquisition unit to acquire a plurality of 1D line images of the measurement target while varying a distance between the image acquisition unit and the measurement target,
the controller being configured to generate a two-dimensional (2D) scan image from combining the plurality of 1D line images, and the controller being configured to detect a pattern of the measurement target based on comparing a plurality of 2D reference images and the 2D scan image.

22. The optical measurement apparatus according to claim 21, wherein the controller is configured to:
calculate differences between the plurality of 2D reference images and the 2D scan image; select a 2D reference image having a minimum difference from the 2D scan image among the plurality 2D reference images; and
determine that a critical dimension of the pattern of the measurement target is the same as a critical dimension of a pattern of a reference target corresponding to the selected 2D reference image.

23. The optical measurement apparatus according to claim 21, wherein the controller is configured to:
calculate mean squares of differences between luminous intensities of pixels of the 2D scan image and luminous intensities of corresponding pixels of the plurality of 2D reference images;
select a 2D reference image having a minimum mean squares of differences in luminous intensity of pixels from the 2D scan image among the plurality of 2D reference images; and
determine that a critical dimension of the pattern of the measurement target is the same as a critical dimension of a reference target corresponding to the selected 2D reference image.

24. The optical measurement apparatus according to claim 21, wherein the controller is configured to:
calculate mean of absolute values of differences between luminous intensities of pixels of the 2D scan image and luminous intensities of corresponding pixels of the plurality of 2D reference images;
select a 2D reference image having a minimum mean absolute value differences in luminous intensity of pixels from the 2D scan image among the plurality of 2D reference images; and
determine that a critical dimension of the pattern of the measurement target is the same as a critical dimension of a reference target corresponding to the selected 2D reference image.

25. A method of controlling an optical measurement apparatus, the method comprising:
acquiring a plurality of 1D line images by measuring an intensity of an interference phenomenon generated between reflected or scattered light beams from of a measurement target while varying a distance between an image acquisition unit and the measurement target;
generating a 2D scan image from combining the plurality 1D line images;
detecting a pattern of the measurement target based on comparing the 2D scan image to a plurality of 2D reference images.

26. The method according to claim 25, wherein the detecting the pattern of the measurement target includes:
calculating differences between the plurality of 2D reference images and the 2D scan image;
selecting one of the plurality of 2D reference images that has a minimum difference from the 2D scan image among the differences between the plurality of 2D reference images; and
determining a critical dimension of the pattern of the measurement target is the same as a critical dimension of a pattern of a reference target corresponding to the selected 2D reference image.

27. The method according to claim 25, wherein the calculating differences between the plurality of 2D reference images and the 2D scan image includes calculating mean squares of differences between luminous intensities of pixels of the 2D scan image and luminous intensities of corresponding pixels of the 2D reference image as the difference between the 2D scan image and the 2D reference image.

28. The method according to claim 25, wherein the calculating differences between the plurality of 2D reference images and the 2D scan image includes calculating mean absolute values of differences between luminous intensities of pixels of the 2D scan image and luminous intensities of corresponding pixels of the 2D reference image as the difference between the 2D scan image and the 2D reference image.

29. An optical measurement apparatus comprising:
a station configured to support a measurement target;
an image acquisition unit configured to acquire a one-dimensional (1D) line image corresponding to luminous intensity of an interference phenomenon generated between reflected or scattered light beams from the measurement target;
a driver configured to adjust a distance between the station and the image acquisition unit; and
a controller,
the controller being configured to control the driver and the image acquisition unit while the driver adjusts the distance between the station and the image acquisition unit to a plurality of different distances and the image acquisition unit acquires a plurality of 1D line images of the measurement target,
each one of the plurality of 1D line images being acquired at a different one of the plurality of different distances,
the controller being configured to generate a two-dimensional (2D) scan image from the plurality of 1D line images, and
the controller being configured to detect a pattern of the measurement target based on comparing a plurality of 2D reference images to the 2D scan image.

30. The optical measurement apparatus according to claim 29, wherein the controller is configured to:
calculate differences between the plurality of 2D reference images and the 2D scan image;
select a 2D reference image having a minimum difference from the 2D scan image among the plurality of 2D reference images; and
determine that a critical dimension of the pattern of the measurement target is the same as a critical dimension of a pattern of a reference target corresponding to the selected 2D reference image.

31. The optical measurement apparatus according to claim 29, wherein the 2D scan image and the plurality of 2D reference images include pixels having values corresponding to luminous intensity, and
the controller is configured to,
calculate mean squares of differences between the luminous intensities of pixels in the 2D scan image and the luminous intensities in corresponding pixels in the plurality of 2D reference image,
select a 2D reference image having a minimum mean square difference in luminous intensities of pixels among the plurality of 2D reference images compared to the 2D scan image, and
determine that a critical dimension of the pattern of the measurement target is the same as a critical dimension of a pattern of a reference target corresponding to the selected 2D reference image.

32. The optical measurement apparatus according to claim 21, wherein the driver configured to move the station in a direction perpendicular to the measurement target.

33. The optical measurement apparatus according to claim 21, wherein the measurement target is non-repeating the measurement target.

34. The optical measurement apparatus according to claim 25, wherein the distance between the image acquisition unit and the measurement target varies in a direction perpendicular to the measurement target.

35. The optical measurement apparatus according to claim 25, wherein the measurement target is non-repeating the measurement target.

36. The optical measurement apparatus according to claim 29, wherein the driver configured to move the station in a direction perpendicular to the measurement target.

37. The optical measurement apparatus according to claim 29, wherein the measurement target is non-repeating the measurement target.
